(19) United States
(12) Patent Application Publication
(10) Pub. No.: US 2016/0137468 A1
(43) Pub. Date: May 19, 2016

(54) MODULAR PORTABLE LIFTING DEVICE

(71) Applicant: John Walker, San Diego, CA (US)

(72) Inventor: John Walker, San Diego, CA (US)

(21) Appl. No.: 14/543,756

(22) Filed: Nov. 17, 2014

(51) Int. Cl. B66F 9/07; B66C 23/48

(52) U.S. Cl. CPC B66F 9/07; B66C 23/48

(57) ABSTRACT

A modular and portable crane and forklift device is provided which is easily assembled and disassembled without requiring extraneous tools. The device composed of tubing components engaged to form an elongated lifting strut employs the force that a user imparts on a winch which is communicated to one or more cables and pulleys, to elevate and lower a load. The winch is positionable at ground level or an elevated position.

### FIELD OF THE INVENTION

The present device relates to a lifting device. More particularly the disclosed device, relates to a modular device that is capable of lifting heavy loads, which is easily assembled and disassembled without requiring extraneous tools and is thus compact for transport and storage.

### BACKGROUND OF THE INVENTION

Cranes and forklifts have been used for commercial and home construction and repair for decades. Conventional cranes are either a vehicle themselves, or are vehicle-mounted and require professional operators. Conventional forklifts while smaller than cranes, are still conventionally powered by an engine, heavy, and driven by trained operators. Consequently, such devices do not lend themselves to employment in a home setting.

To decrease the cost, and for extended applications, more portable cranes and smaller forklifts have been developed over the years. These devices, which lift with or without the aid of external motors or engines, are still conventionally large and must either be towed or driven to their location, or be assembled in situ. Being large and heavy, such assemblies are cumbersome, generally require an engine or motor, and are hard to assemble and configure and require multiple tools.

As such, there is an unmet need for a portable crane and forklift device, which is lightweight, and which can be assembled and disassembled with minimal additional extraneous tools. Such a device, when employed, should allow the user to lift a load heavier or bulkier than they could lift by hand through the employment of means for winding and translating a cable which provides mechanical advantage such as by a simple winch. Such a device should enable the user to lift weight and bulky items at least to the height of a roof which would serve the majority of a homeowner's needs.

Further, such a device must be an easily assembled structure using few tools, and so assembled, have pulleys to communicate the mechanical force from the winch, through a cable, to a lifting component. Preferably, assembly of the connections of the device, should be made through means contained within the device.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### OBJECTS OF THE INVENTION

It is an object of the present invention to provide a portable lifting device for heavy objects which is easy to assemble.

It is an additional object of this invention for the assembled device to function like a forklift or crane yet be easy to assemble and dissemble without additional tools.

It is a further object of this invention to provide such a lift which may be operated from a ground position or an elevated position such as a roof.

These and other objects, features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### SUMMARY OF THE INVENTION

In accordance with the purposes of the present invention, as embodied and broadly described herein, the present invention provides a device configured in a first preferred mode as an easily transportable forklift, which is easy to assemble and disassemble to a small easily stored and transported collection of modular components.

The device herein in a preferred mode features two substantially parallel base struts, each having a caster at each end for easy rolling of the assembled device. The base struts are connected by at least one substantially perpendicular bridge strut.

Attaching perpendicular to the base, and rising vertically above the bridge strut, a first vertical strut is engageable as a base support which has a mount engageable to a plurality of angled chains or cables or other supports. A winch mount engaged centrally along a strut member is configured to engage adjacent the upper end of the first vertical strut, or at an elevated position operable from a roof or ladder or the like for lifting. In the modular configuration of the device, one or more extension struts can be attached above or below the winch-engaged strut and the support strut rising from the base, to prevent tipping and thereby to extend the ultimate height to which the device can lift an object.

As noted, one or more cables or chains communicate from a horizontally disposed mounting plate, which when tightened using a translating threaded member and nut, form a reinforced and rigid base.

A cable communicating from the winder at a first end and through an opening in a top-mounted block, and around the engaged pulley positioned at a peak of the device atop the highest extension strut, when translated by a winding of the winch, will raise or lower the lifting component of the device. A tightening of the cable by operation of the winch thus pulls upon and lifts a translating forklift member, which is configured to translate along the struts rising from the base, in their operative engagement with one another. While the term winch is employed throughout the specification herein and in the claims, such includes any device capable of winding and unwinding a cable or chain, which provides the user mechanical advantage while doing so, and should not in any fashion be considered limiting.

The cable is configured with removable means for engagement to attach and detach the distal end to and from the forklift member. One or a combination of such means of engagement can be employed such as clasps, screws, carabineers, hooks or chains.

A top-mounted pulley block includes an insertable tube body that is welded or bolted or otherwise operatively engaged to a pulley base which is engaged operationally with the pulley. Especially preferred, a semicircular slot or recess at each end of the mounted pulley, when operatively engaged, creates a cable channel on opposing sides of the pulley to maintain the cable on track during use. Especially important in the device, a removable slot cap positionable over each slot, constrains the cable within the pulley slot during use. The two covered slots aligned with the recess of the pulley, prevent the cable from dislodging from the attached top pulley during operation or translating out of alignment with the centerline of the pulley.

In one mode, the forklift member is mainly composed of a substantially C-shaped forklift which is permanently welded, adhered or bolted to extend away from a translating member. The translating member is configured with a vertical slot, which allows it to remain engaged when translating to and from an elevation, and to slide past the projecting winch engagement from the supporting member or strut for the winch. Optionally, the translating member may have operationally positioned pads on its internal faces to reduce the force of friction as it is pulled by the cable upwards or allowed to descend.

In another mode, the forklift member is provided in a user assembleable mode. This allows the user to not only collapse the fork member for transport and storage, but also to adjust the distance of separation of the projecting forks for various loads.

The member supporting the winch and the extension, struts should be mainly composed of rectangular tubing to allow for a cooperative fixed sliding engagement of the forklift member. This rectangular engagement also provides a means to prevent forklift member rotation during ascent and descent.

The engageable rigid members forming the mount for the winch support plate, and extending member components in the assembled device, preferably each contain a male connection at one end, adapted for engagement with a mating socket of another component. The male connection can preferably be composed of a piece of square tubing that is sized for insertion into cooperative receiving cavities of adjacent members. The male connection may be welded to the main body of the rigid member or otherwise permanently engaged.

Such a male connection adapted to removably engage with cooperative cavities of the adjacent open ends of adjacent members, will allow for the assembly of a modular extended lifting member through the easy engagement of the strut components from a disassembled state. The connections should additionally contain a mating pin that engages with or through an aperture in the receiving cavity, to prevent separation during use. Preferably, a biased pin on at least one of the male connection's four outer faces is positioned to operatively engage with cooperating apertures in the cavity of the adjacent strut to which it engages. The pin may be biased outward by an engaged spring steel component or other means for biasing.

Alternatively, the aperture engaging pins can be removable, and contain means to tie to the struts to prevent loss or damage, or the connection between struts can be made through clamps, clasps or tie downs but should not require tools to assemble or disassemble. Similarly, brackets with mating features in each base strut connect and constrain the bridge strut, which mates with the winch strut.

The winch assembly engaged with a strut or member, can be positioned at the lower end of the assembled device, or at an upper end of the assembled device. This means for multiple-positioning of the winch allows users to operate the lift device from the ground, from a ladder, or from a rooftop, to lift a load.

In another preferred mode the device it can be configured to function to lift like a crane by adding a projecting crane boom strut. The crane boom strut is configured of two welded, adhered or bolted sections of square tubing. In this mode of the device, a cable is strung from the load, over the first crane pulley and a second crane pulley and to the winch through the cable slot cut through the crane boom strut's vertical corner face. The winch may be positioned adjacent the ground or support surface, or adjacent the upper end of the formed elongated member from the different components to operate the device from either position.

The struts, brackets, pulleys and pins of the device herein can be composed of one or a combination of materials from a group including aluminum, steel, carbon fiber, reinforced fiberglass, and plastic. Additionally, the sliding member pads can be composed of one or more of the following materials from a group of pad materials including teflon, delrin, nylon, acrylic or polymeric material, or may be replaced by ball bearings or linear slides.

The pulleys are preferably made of nylon or other polymeric material for a smooth ride, but can alternatively be constructed from any material including but not limited to: aluminum, steel, carbon fiber or plastic depending on the intended use and geographic area of use should rust be a problem. The cables may be composed of one or more materials in a list including but not limited to string, rope, twine, cable, wire rope or chain. Finally, the base casters can be provided by any conventional wheel which is sufficiently stable and durable and will roll with the weight of the device and a load, including fixed or omnidirectional wheels. Tie down and guide wires or chains as noted are preferably employed for additional stability.

With respect to the above description, before explaining at least one preferred embodiment of the herein disclosed invention in detail, it is to be understood that the invention is not limited in its application to the details of construction and to the arrangement of the components in the following description or illustrated in the drawings. The device herein described and disclosed in the various modes and combinations is also capable of other embodiments and of being practiced and carried out in various ways which will be obvious to those skilled in the art. Any such alternative configuration as would occur to those skilled in the art is considered within the scope of this patent. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other portable cranes and forklift devices for carrying out the several purposes of the present disclosed device. It is important, therefore, that the claims be regarded as including such equivalent construction and methodology insofar as they do not depart from the spirit and scope of the present invention.

### BRIEF DESCRIPTION OF DRAWING FIGURES

The accompanying drawings, which are incorporated herein and form a part of the specification, illustrate some, but not the only nor exclusive examples of embodiments and/or features of the disclosed device. It is intended that the embodiments and figures disclosed herein are to be considered illustrative of the invention herein, rather than limiting in any fashion.

In the drawings:

FIG. 1 depicts an isometric view of one preferred mode of the device showing a support member operatively engaged with tensioning chains or cables.

FIG. 2 displays an exploded isometric view of the first preferred mode of the device without the support chains or translating cable.

FIG. 2a depicts the device of FIG. 1, showing the winch positionable at the distal or upper end of the assembled device rather than at the lower end in FIG. 2.

FIG. 3 shows an isometric view of another preferred mode of the device adapted as a crane for lifting a load using a projecting boom strut where a cable dropping therefrom is employable to lift a load.

FIG. 4 depicts an isometric view of the winch supporting strut component which is engageable anywhere along the assembled elongated lifting member or formed supporting strut.

FIG. 5 displays an isometric view of the pulley block showing the preferred confined pathway for the translating cable through the covered slots aligned with the centerline of the wheel.

FIG. 6 depicts an isometric view of the device's forklift component showing the sliding member having an internal passage adapted for sliding.

FIG. 6a depicts a mode of the forklift component which may be assembled from stored components and adjusted for width.

FIG. 7 depicts the device showing a configuration where the winch member is engageable from the upper distal end allowing operation to raise and lower the lifting member from an elevated position such as a roof.

FIG. 8 depicts the device similar to FIG. 7 wherein the lifting member operates as a crane to lift material using a cable engaged therewith similar to that of FIG. 3 but with the winch operated from an elevated position.

### DETAILED DESCRIPTION OF THE INVENTION

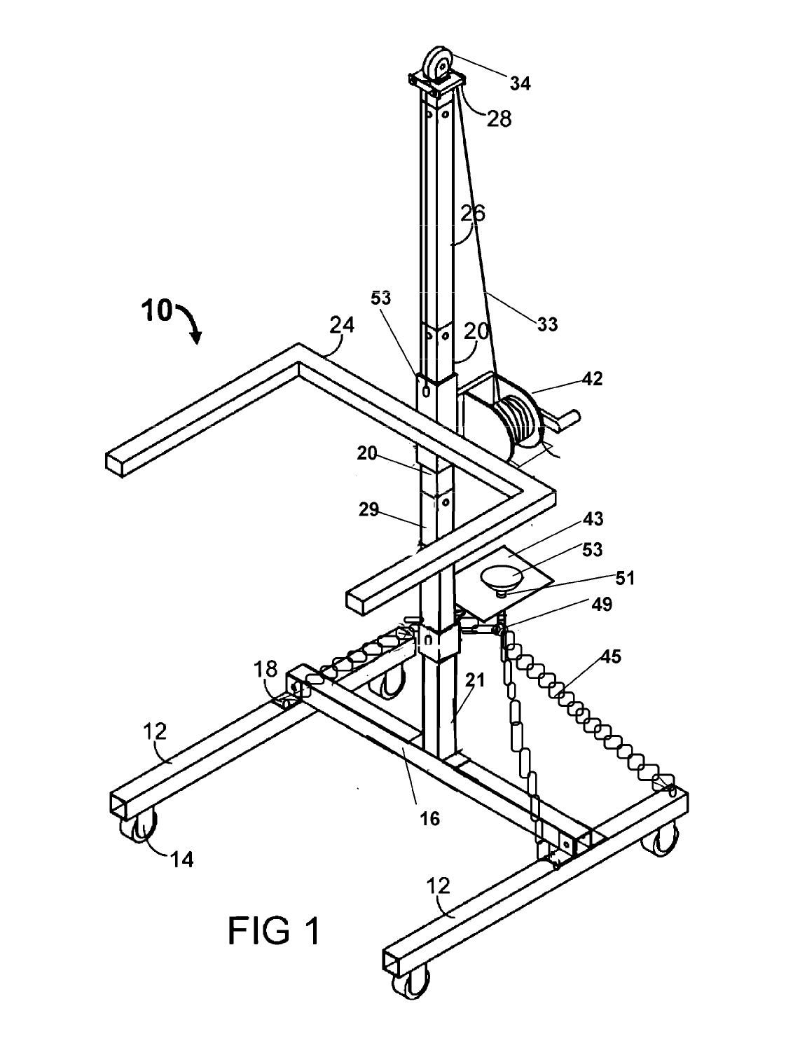

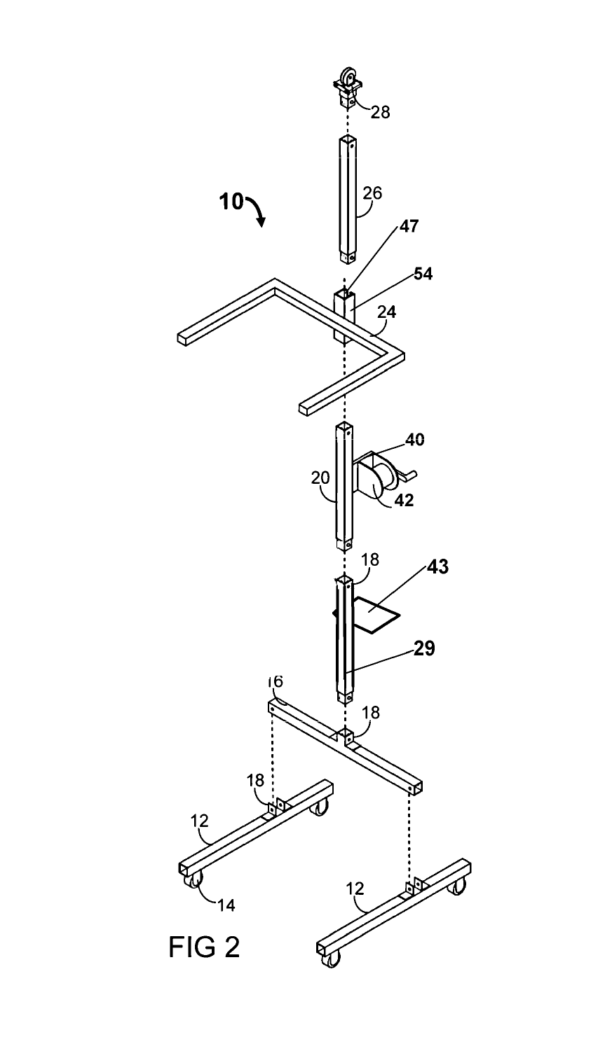

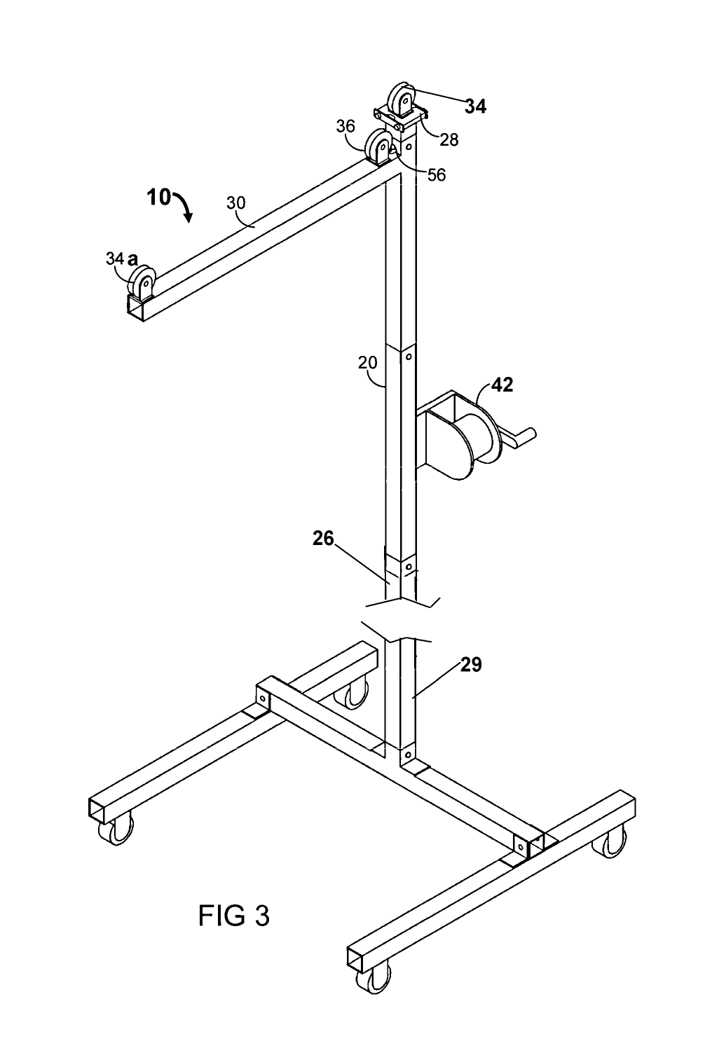

Now referring to drawings in FIGS. 1-8, wherein similar components are identified by like reference numerals, there is seen in FIGS. 1-2, the device 10 configured in on preferred mode as a forklift or lift configuration which is easily assembled and disassembled for compact storage. Depicted is a base component 11 formed by two substantially parallel base struts 12, each having a wheel or caster 14 at each of two ends. The base struts 12 are connected by a traverse or perpendicular bridge strut 16 to the base.

Attachable and rising vertically from a traverse member shown by the bridge strut 16, a first supporting strut 29 is shown having an engaged support member shown as support plate 43, which engages centrally along the path of the first supporting strut 29. Particularly preferred to allow easy disassembly of the base component 11, the supporting strut is in a compressive engagement to the bridge strut 16, provided by tensioned engagement between the support plate 43 and the base struts 12 of a plurality of tightened chains 45 or cables, or similar flexible tensionable support members.

A first end of each flexible member shown as a chain 45 is engaged with one of the base struts 12, and the opposing end of each respective chain 45 is shown attached to an engagement point such as an eye 49, at the distal end of a tensioning member such as a bolt 51 in threaded engagement with the plate 43. In this manner a knob 53 engaged with the bolt 51 allows the user to twist the bolt 51 in the threaded engagement with the plate 43 and to translate the eye 49 in a direction away from the struts 12 to tighten the individual chains 45 taught. This forms a particularly stable base component 11 of the structured device 10.

If disassembly of the base component 11 is not a requirement, the supporting strut 29 can be welded to rise from the other noted components of the rolling base component 11, to provide an engagement at a distal end for the other components herein. However because disassembly for storage and transport is particularly preferred, the tensioned removable engagement with tensioned, and angled flexible members such as chains 45 is particularly preferred of the supporting strut with the rolling base component 11.

A winch 42 or reel or other means for winding cable 33 is configured for translating an engaged cable 33, and the reel or winch 42 thereby engaged with a supporting winch strut 20 is engageable as noted, either in a position adjacent the base component 11 engaged to the supporting strut 29 for use on the ground, or at a more elevated position such as adjacent to the distal end where the pulley block 28, engages with the distal end of the assembled lifting strut formed by the engaged struts of the plate 43 and other similarly engaged struts which may be included for increased height.

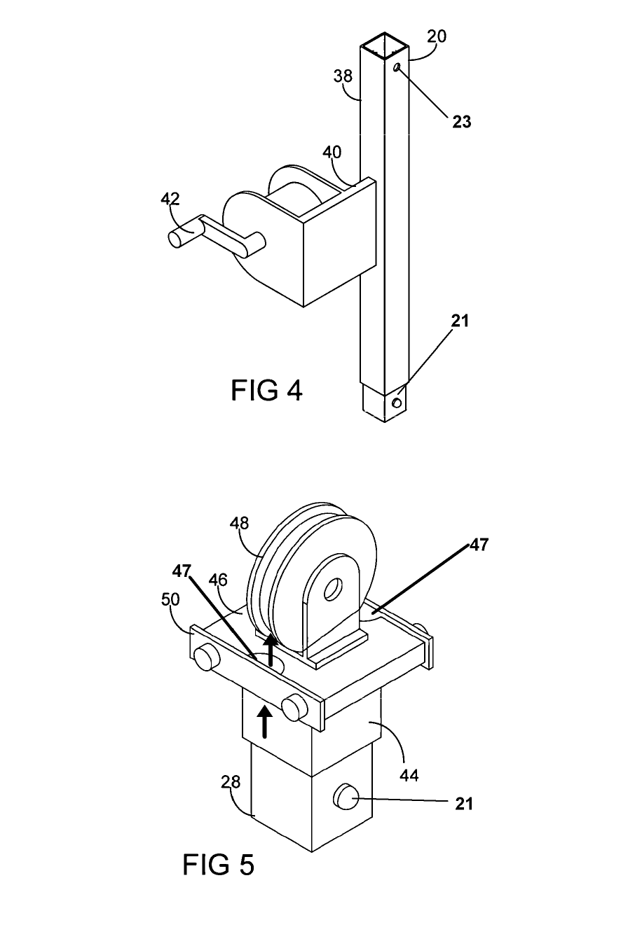

The cable winding mechanism provided by the winch 42 is attached to the winch strut 20 using projecting member shown as a winch plate 40 (FIG. 5), which engages centrally between one wall of the winch strut 20 and to the winch 42. To allow translation of a sliding member 54, past the winch 42 in any position on the assembled device, the diameter of the winch plate 40 is slightly smaller than a gap 47 formed in the sliding member 54 supporting the forklift member 24. This allows the sliding member 54 to translate along the entire pathway formed by the multiple engaged vertically disposed members, past the point of attachment of the engaged winch 42, in the assembled device 10.

One or more elongated flexible load-bearing members, such as chains or shown support cables 41 may be strung from the winch 42, around a pulley block 28, connected atop the highest engaged extension strut 26, to thereby translate the sliding member 54 and at least one attached forklift member 24, which slides along the engaged winch strut 20, and one or a plurality of operatively engaged extension struts 26. The winch strut 20 and the extension struts 26 and the supporting strut 29, are all engageable in an end to end engagement to form a lifting pathway or an elongated lifting strut 37, such as in FIG. 1, extending to a distal end from the base component 11. The cable 41 should be configured to attach and detach from the sliding member 54 supporting the forklift member 24, through one or a combination of means for removable engagement 53 (FIG. 1) including clasps, carabineers, hooks or chains, screws, or other hardware mounts.

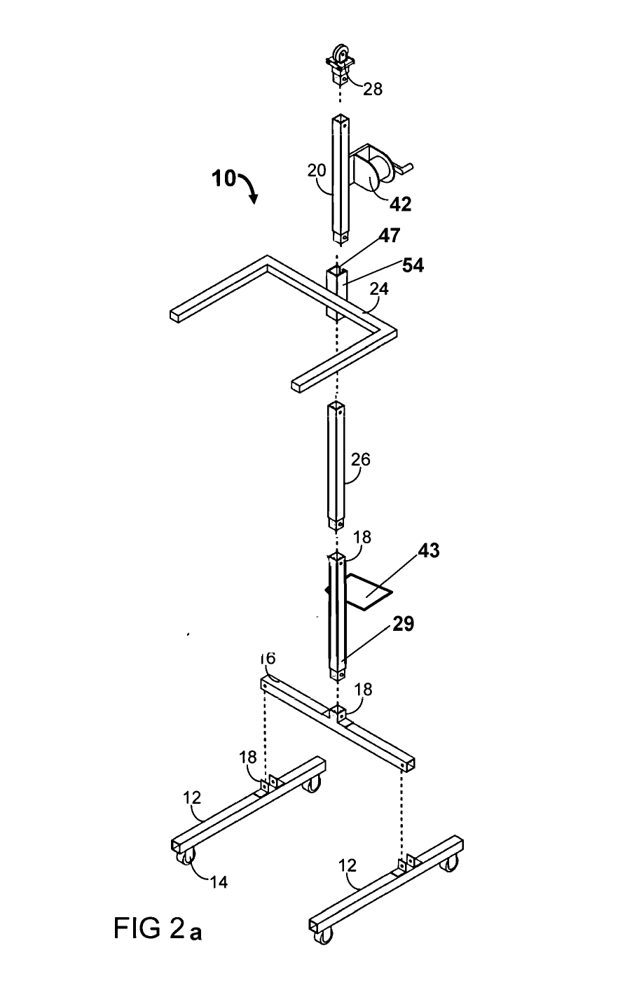

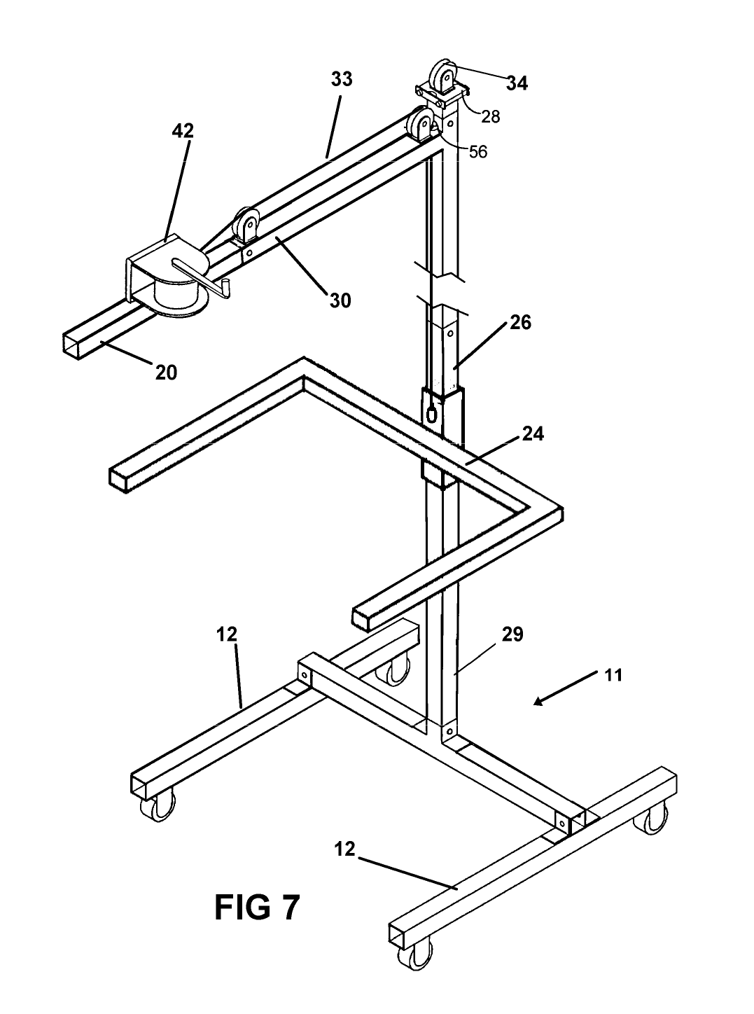

As shown in FIGS. 1, 2, one or more extension struts 26 can be engaged above or below the winch strut 20 which as noted may be engaged adjacent to the base component 11, or the elevated pulley block 28 as needed by the user. Additional extension struts 26 may be engaged end to end with or without the winch strut 20, to extend to a formed elongated lifting strut, such as in FIG. 3 or 7, to a height to which the device 10 can lift an object or load.

The removably engageable insertable first ends of each extension strut 26 are adapted to engage cavities of adjacent extension struts 26 or the supporting strut 29 rising perpendicular from an engagement with the base component 11, and the winch strut 20 which may be located at ground level, or at an upper level of the assembled extension struts 26 forming the elongated lifting strut, thereby allowing winch operations from an elevated position or a ground-based position. FIGS. 2 and 2a depict the device 10 with exploded views of the components showing such configurations.

As shown in FIG. 5, the pulley block 28 includes a square tube body 44 which may be welded, adhered or bolted to a pulley base 46. A semicircular slot 47 at each end of the pulley base 46 creates a cable channel. Engagement of the cable 33 through both slots 47, which align with the center of the pulley, help maintain the cable 33 engaged with the pulley at all times during use.

A removable slot cap 50 allows for insertion of the cable 33 into the slots 47 easily, and forms a cable pathway which constrains the cable 33 within the slots of the base 46 which as noted, prevents the cable 33 from dislodging from the attached top pulley 48 during operation.

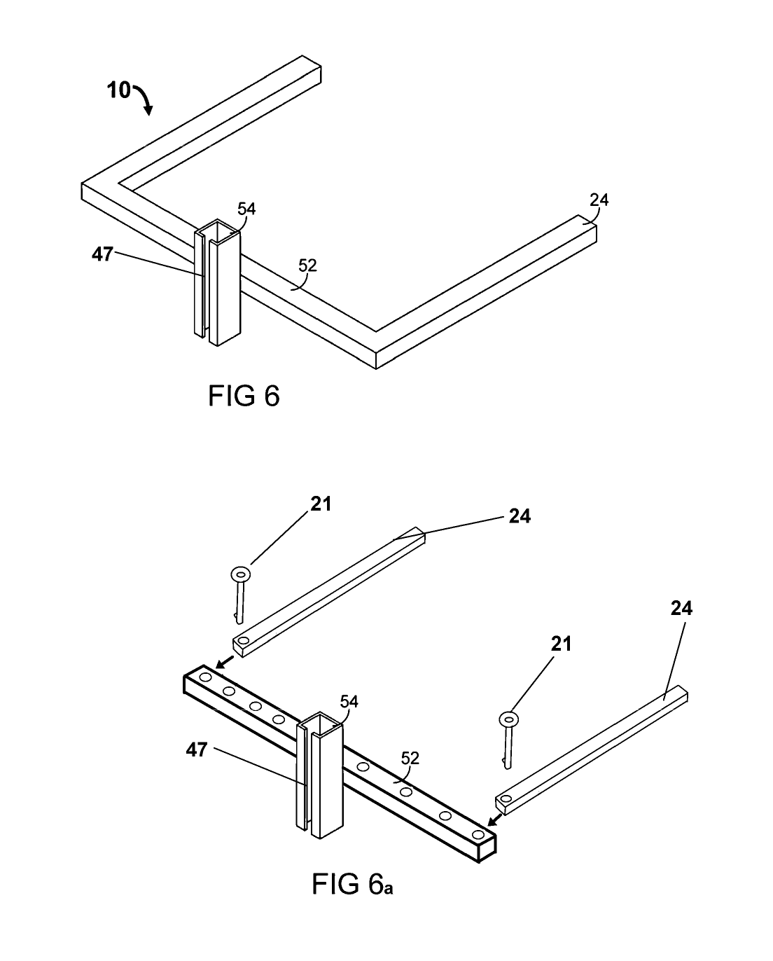

Shown in figure FIGS. 6 and 6a a forklift member 24 is mainly configured as a C-shaped forklift 52 assembly which is either formed of components as in FIG. 6a, or permanently welded, adhered or bolted to a sliding member 54 as in FIG. 6. The sliding member 54 includes a vertical slot 47, which allows it to slide past the smaller diameter winch plate 40, and can contain pads on its internal faces to reduce the force of friction as it is pulled upwards or downwards. The forklift member 24 or members as shown in FIG. 6a, may be formed of components and using pins 21 assembled and so engaged to the sliding member provides means to engage a load to the sliding member for elevating or lowering by engaging the forklift member through or to the load such as a load on a platform or pallet.

The strut member 38, and the extension struts 26 should be mainly composed of square tubing to prevent fork lift member 24 rotation when operatively engaged with adjacent extension struts 26 and components forming the lifting strut, during ascent and descent. The above components should each contain a male connection at one end, which can preferably be composed of a piece of projecting square tubing that is inserted into and welded to its main body. Such a connection should allow the strut components to connect rigidly and easily and should additionally contain a mating pin and hole to prevent separation during use. Preferably such a connection includes as shown, as at least one biased or sprung pin 21 engaged with at least one matching apertures 23 formed in the mating strut component engagement.

Alternatively, the pins 21 can be removable, and contain means to tie to the joined struts to prevent loss or damage, or the connection between struts can be made through clamps, clasps or tie downs but should not require tools to assemble or disassemble. Similarly, brackets 18 with mating features in each base strut 12 connect and constrain the bridge strut 16, which mates with the winch strut 20.

In another preferred mode of the device 10, per FIG. 3, the device 10 is configured for operation as a crane by adding a crane boom strut 30, which is composed of two welded, adhered or bolted sections of square tubing or might be engageable using the pin and aperture engageable ends as in other struts shown herein. In this mode, the cable 33 may be strung from the load, over the first crane pulley 34a, and a second crane pulley 34 and then to the winch 42 through a cable slot 54 cut through the crane boom strut's 30 vertical corner face.

In all modes of the device 10 the struts, brackets, pulleys and pins can be composed of one or a combination of materials in a group including but not limited to: aluminum, steel, carbon fiber, reinforced plastic. Additionally, the sliding member 54 pads can be composed of one or more of the following materials including but not limited to: TEFLON, nylon, delrin, acrylic or other polymeric materials suitable to the task, or may be replaced by ball bearings or linear slides. The pulleys are preferably made of rubber but can alternatively be constructed from any material including but not limited to aluminum, steel, carbon fiber or plastic. The cables may be composed of one or more materials in a list including but not limited to string, rope, twine, cable, wire or chain.

Further, the casters 14 engaged with the base component 11, can also be provided by any common wheel that is sufficiently stable and durable including but not limited to standard or omnidirectional wheels. Tie downs and guide wires or chains 27 as in FIG. 1, may be employed for additional stability to the vertically disposed supporting strut 29 and to allow disassembly of the base component 11.

Shown in FIG. 7, the device 10 due to the interchangeable components can also be assembled to a configuration where one end of the winch member 20 is configured to be engageable at the distal end of the strut boom 30, adjacent the secondary pulley, to allow operation by a user in an elevated position adjacent a distance of length of the strut boom 30 from the assembled device. The device 10 is easily configurable to this mode for elevated operation by placement of extension struts 26 in the position of the winch member 20 such as in FIG. 1. This mode works especially well with the user in an elevated position but a distance adjacent the formed elongated strut member also, such as on a roof or the like where the user can operate the winch to elevate a load for positioning on the roof.

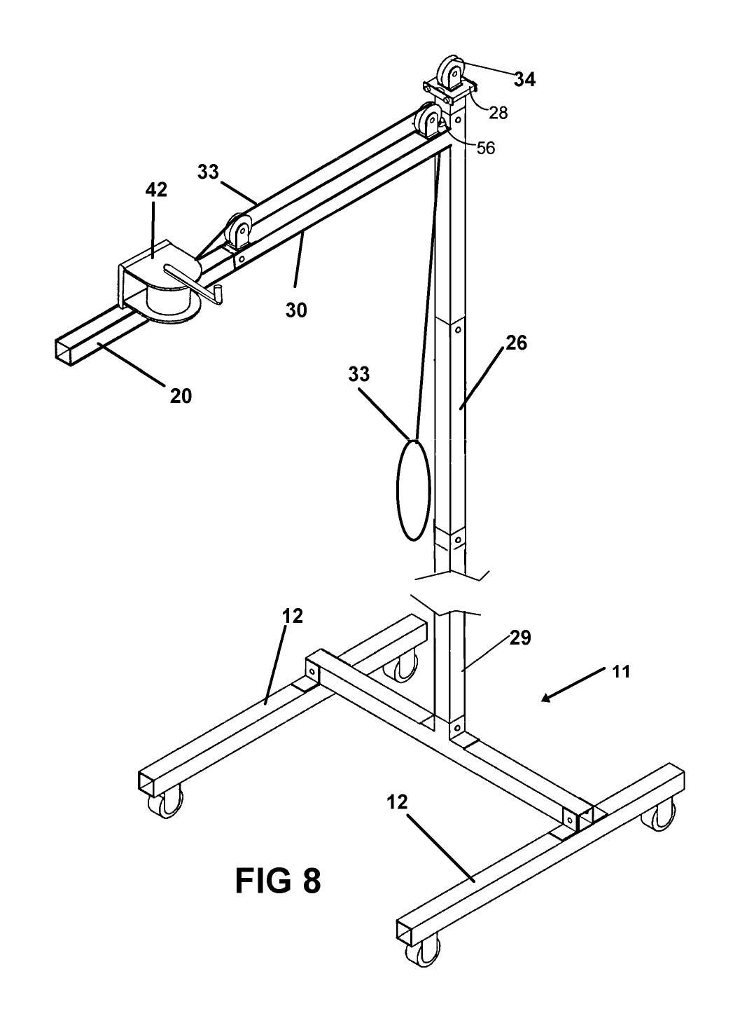

FIG. 8 depicts the device 10 assembled in a mode similar to FIG. 7, however in the mode the cable 33 is disengaged from the lift member 24 and instead employs a loop or hook or other engagement device on the distal end of the cable 33 to connect it to a load for lifting. Again this configuration of the components of the device 10 works well with the user in an elevated position such as on a roof, or on a pole or in another elevated situation where a load needs lifting to that position. Using the winch member 20 engaged in a horizontal disposition in this mode and that of FIG. 8, the user can be located adjacent the device 10 as assembled and easily operate the cable 33 using the winch to lift a load to their position.

As noted, any of the different configurations and components can be employed with any other configuration or component shown and described herein. Additionally, while the present invention has been described herein with reference to particular embodiments thereof and steps in the method of production, a latitude of modifications, various changes and substitutions are intended in the foregoing disclosures, it will be appreciated that in some instance some features, or configurations, or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims. Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A modular lifting device, comprising:
a base component having wheels extending from a first side adapted for a rolling engagement with a support surface;
a supporting strut extending to a distal end along a vertical disposition from an engagement of a first end thereof to a second side of said base component, opposite said first side;
a winch, said winch engaged between a first end and a second end of a winch strut;
at least one extension strut;
said winch strut, said extension strut, and said supporting strut configured for an engagement in an end to end engagement thereof, to form an elongated lifting strut extending from said base component to a distal end;
a pulley rotationally engaged on a first side of a pulley block, said pulley block having a second side configured to engage with said distal end of said formed elongated lifting strut;
a sliding member having a sidewall defining an interior passage configured to translate in an engagement upon said elongated lifting strut;
a cable extending over said pulley from a first end engageable with said sliding member to a second end engaged with said winch;
means for engagement of said sliding member to a load to be elevated or lowered; and
said winch operable to wind and unwind said cable thereon thereby providing means for translating said sliding member on said elongated lifting strut between a lowered position closest to said support surface and an elevated position closest to said pulley, whereby a user employing said winch with said sliding member operatively engaged with a load, can lift or lower said load.

2. The modular lifting device of claim 1, additionally comprising:
said winch strut engageable to a first position in said end to end engagement engaged to said supporting strut;
said winch strut engageable to a second position to said elongated lifting strut engaged adjacent said pulley; and
said winch engaged to said winch strut in said first position operable by a user positioned on said support surface and in said second positron being operable by a said user in an elevated positioning such as on a roof.

3. The modular lifting device of claim 1, additionally comprising:
said engagement of said first end of said supporting strut to said second side of said base component being a removable engagement of said first end with a bracket engaged with said base component.

4. The modular lifting device of claim 2, additionally comprising:
said engagement of said first end of said supporting strut to said second side of said base component being a removable engagement of said first end with a bracket engaged with said base component.

5. The modular lifting device of claim 3, additionally comprising:
a plurality of tensional support members engaged at first ends with said base component and at respective second ends to a connection to tensioning member engaged with said supporting strut;
said tensioning member operable to translate said connection toward and away from said base, and
whereby a translation of said connection in a direction away from said base imparts tension to each of said tensional support members thereby biasing said supporting strut into said engagement with said bracket.

6. The modular lifting device of claim 4, additionally comprising:
a plurality of tensional support members engaged at first ends with said base component and at respective second ends to a connection to tensioning member engaged with said supporting strut;
said tensioning member operable to translate said connection toward and away from said base, and
whereby a translation of said connection in a direction away from said base imparts tension to each of said tensional support members thereby biasing said supporting strut into said engagement with said bracket.

7. The modular lifting device of claim 1 wherein said means for engagement of said sliding member to a load to be elevated or lowered comprises:
at least one projecting member extending from an engagement at a first end with said sliding member, to a distal end.

8. The modular lifting device of claim 3 wherein said means for engagement of said sliding member to a load to be elevated or lowered comprises:
at least one projecting member extending from an engagement at a first end with said sliding member, to a distal end.

9. The modular lifting device of claim 5 wherein said means for engagement of said sliding member to a load to be elevated or lowered comprises:
at least one projecting member extending from an engagement at a first end with said sliding member, to a distal end.

10. The modular lifting device of claim 1 additionally comprising:
said winch engaged to an extension member engaged to said winch strut between said first end and a second end thereof;
a slot formed in said sidewall of said sliding member;
said slot having a width larger than a diameter of said extension member; and
whereby said sliding member during a translation on said elongated lifting strut is slidable along said winch strut portion of said end to end engagement forming said elongated lifting strut, by a passage of said extension member through said slot during said translation of said supporting strut.

11. The modular lifting device of claim 2 additionally comprising:
said winch engaged to an extension member engaged to said winch strut between said first end and a second end thereof;
a slot formed in said sidewall of said sliding member;
said slot having a width larger than a diameter of said extension member; and
whereby said sliding member during a translation on said elongated lifting strut is slidable along said winch strut portion of said end to end engagement, by a passage of said extension member through said slot during said translation of said supporting strut.

12. The modular lifting device of claim 4 additionally comprising:
said winch engaged to an extension member engaged to said winch strut between said first end and a second end thereof;
a slot formed in said sidewall of said sliding member;
said slot having a width larger than a diameter of said extension member; and
whereby said sliding member during a translation on said elongated lifting strut is slidable along said winch strut portion of said end to end engagement, by a passage of said extension member through said slot during said translation of said supporting strut.

13. The modular lifting device of claim 6 additionally comprising:
said winch engaged to an extension member engaged to said winch strut between said first end and a second end thereof;
a slot formed in said sidewall of said sliding member;
said slot having a width larger than a diameter of said extension member; and
whereby said sliding member during a translation on said elongated lifting strut is slidable along said winch strut portion of said end to end engagement, by a passage of said extension member through said slot during said translation of said supporting strut.

14. The modular lifting device of claim 1 additionally comprising:
a strut boom engageable at a first end with said distal end of said elongated lifting strut, said strut boom extending in a horizontal disposition to a distal end;
a secondary pulley positioned adjacent said distal end of said strut boom;
said cable extending over said pulley and said secondary pulley to a distal end, from said second end engaged with said winch; and
said distal end of said cable engageable with a load to be lifted.

15. The modular lifting device of claim 1 additionally comprising:
a strut boom engaged at a first end to said elongated lifting strut adjacent a distal end thereof, said strut boom extending in a horizontal disposition to a distal end of said strut boom;
said winch strut engageable with said distal end of said strut boom to extend therefrom thereby positioning said winch in an elevated position adjacent said distal end of said elongated lifting strut; and
said winch operable by a user adjacent said elevated position of said winch.

16. The modular lifting device of claim 2 additionally comprising:
a strut boom engaged at a first end to said elongated lifting strut adjacent said distal end of said elongated lifting strut, said strut boom extending an extension distance in a horizontal disposition to a distal end;
said winch strut engageable to a third position, with one end of said winch strut engaged to said distal end of said strut boom to extend therefrom, thereby positioning said winch in an elevated position adjacent said distal end of said elongated lifting strut; and
said winch engaged with said winch strut in said third position operable by a user positioned in an elevated position in an adjacent position to said elongated lifting strut, said adjacent position located a distance at least equal to said extension distance of said strut boom.
